(19) United States
(12) Patent Application Publication
(10) Pub. No.: US 2013/0111802 A1
(43) Pub. Date: May 9, 2013

(54) SELF-OPENING INSECT TRAP AND LURE

(71) Applicant: Allan Cameron Oehlschlager, Santo Domingo (CR)

(72) Inventor: Allan Cameron Oehlschlager, Santo Domingo (CR)

(21) Appl. No.: 13/462,542

(22) Filed: May 2, 2012

Related U.S. Application Data
(60) Provisional application No. 61/518,457, filed on May 4, 2011.

(51) Int. Cl. A01M 1/14; A01M 1/10

(52) U.S. Cl. CPC A01M 1/14; A01M 1/10
USPC 43/114; 43/107; 43/132.1

(57) ABSTRACT

A self-opening insect trap and lure is described which may be packaged such that, when opened, the trap deploys and the lure becomes available.

### CROSS-REFERENCE TO RELATED APPLICATIONS

This application claims priority benefit of U.S. Provisional Patent Application No. 61/518,457 (Docket # AO-1), entitled “Self-Opening Insect Trap and Lure,” filed May 4, 2011, by Allan Cameron Oehlschlager, which is incorporated herein by reference.

### FIELD

This specification generally relates to an insect trap and lure.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Even though there have been many technical advances in preventative entomology, insects still present a serious problem both hygienically and economically. Insects attack food-producing plants, produce, transport disease-producing organisms, cause pain and discomfort (such as by biting and stinging), and are nuisances in many other ways. Various methods have been devised in an attempt to control various insect pests but have not always been found to be satisfactory for many applications. Most chemical insecticides are toxic and hazardous to birds, fish, animals, and even humans and even in relatively small amounts. Even extremely minute amounts of insecticides are hazardous to some species. The damage caused to the environment by insecticides is sometimes greater than the total benefit obtained through the use of insecticides. Thus, the search has continued for economical, effective, convenient, and non-hazardous methods to control insects. Methods to monitor harmful insects are needed to identify the best treatment.

In addition, methods under at least some situations may be desirable to identify and monitor insect populations, so as to be able to plan safe effective ways to control negative insects while protecting the insects needed for a healthy environment.

There are insect traps that retain insects by adhesive materials. Some insect traps use an attractant to attract the target insects to the trap and then, when the attracted insects touch the adhesive, they are retained in the trap. However, the trap is bulky to ship three dimensional insect traps with sticky surfaces already assembled. Methods have been devised to ship three dimensional traps folded so that the three dimensional traps may be easily reconfigured or assembled into their three dimensional forms when the three dimensional traps have arrived at their destination and the user is ready for deploying the traps. Among the designs available are traps that fold from a flat piece of semi flexible sheet into triangles (U.S. Pat. Nos. 6,516,558, 4,961,282, 1,112,064), squares (U.S. Pat. Nos. 3,755,958, 1,118,845), four and three sided pyramids (U.S. Pat. Nos. 4,133,137, 1,071,578) and circular designs (U.S. Pat. No. 3,863,384). The trap described in U.S. Pat. No. 3,755,958 is commonly known as a diamond trap and is commonly used to monitor grain infesting moths.

### SUMMARY

Embodiments of the invention include self-opening insect traps that may be used in the field quickly, easily, and without loss of the attractant. In some embodiments, the traps include attractant(s) that are released upon the opening of the trap. In some embodiments, the trap is opened by pulling on tabs on opposite sides of the trap. In some embodiments, the attractant is enclosed in a seal that is pulled free upon opening of the trap. In some embodiments, the insect trap may also include an insect-retaining adhesive that may be in the same place as the attractant and/or in close proximity to the attractant. In some embodiments, the insect trap is packaged in the closed form within a wrap singly or in multiples.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE FIGURES

In the following figures like reference numbers are used to refer to like elements. Although the following figures depict various examples of the invention, the invention is not limited to the examples depicted in the figures.

FIG. 1A is a perspective view of an embodiment of an insect trap folded prior of deployment.

FIG. 1B is a perspective view of an embodiment of an insect trap partly folded for shipping so in a first stage for being deployed.

FIG. 2 is a perspective view of an embodiment of the insect trap of FIG. 1B in which the trap shown in FIG. 1B is cut along Plane 145, so that the cross section along plane 145 is visible.

FIG. 3 is a perspective view of an embodiment of the insect trap of FIG. 2 that shows the opening of the seal (which allows the attractant to evaporate).

FIG. 4 is a perspective view of an embodiment of the insect trap of FIG. 3 that shows a more advanced stage of separation than FIG. 3.

FIG. 5 is a perspective view of an embodiment of the insect trap of FIG. 4 in which the side of the trap to the left and to the right of plane 145 (FIG. 4) is shown.

FIG. 6 is a perspective view of an embodiment of the insect trap of FIG. 5 but in which the separation of tab 130 of the trap body from tab 140 of the trap body is greater than shown in FIG. 5.

FIG. 7A is a perspective view of an embodiment of the insect trap of FIG. 6 but in which the separation of tab 130 of the trap body from tab 140 of the trap body is at the usual amount of separation for use of the trap.

FIG. 7B is a perspective view of an embodiment of the insect trap of having a hanger.

FIG. 8 shows an embodiment of a method of activating the trap.

FIG. 9 shows the average (and SEM) time in seconds to deploy a Diamond trap compared to a Diamond trap with a separate lure that opens at the same time the Diamond trap is opened.

FIG. 10 shows the average (and SEM) captures of Plodia interpunctella in diamond traps containing 5 mg of Z9, E12-tetradecadien-1-yl acetate in an adhesive which have been prepared fresh or stored for 6 months under three different temperature conditions. Captures in these traps are compared with captures in traps prepared with separate lures.

FIG. 11 shows a flow chart of an embodiment of method 1100 of making the trap shown in FIGS. 1A-7

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

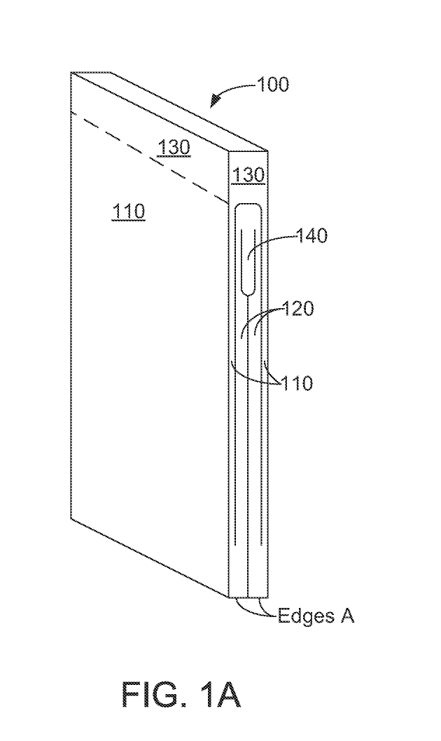

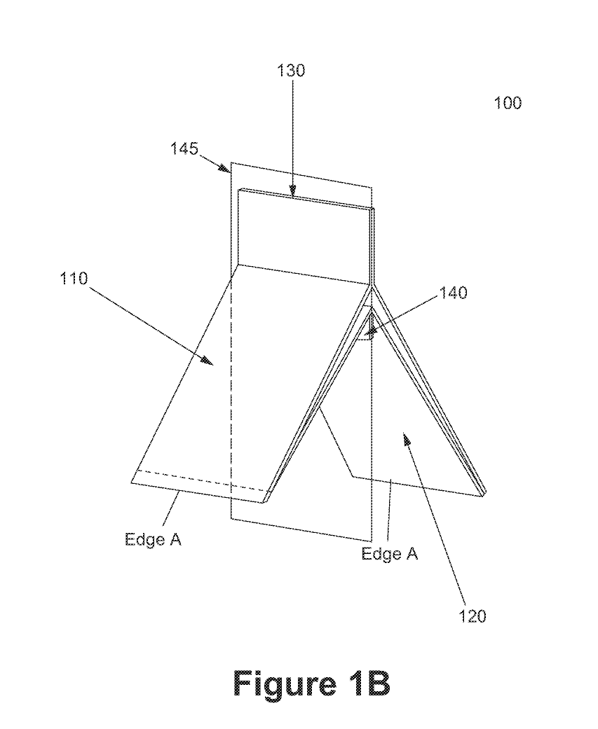

Referring now in detail to the accompanying FIGS. 1A-11, an insect trap is discussed that can contain an attractant source sealed in an impermeable membrane enclosure (a lure package) in such a manner that the motion by which the trap is opened or modified for use causes the impermeable membrane to be pulled off or ruptured so that the attractant is allowed to be released. In the FIGS. 1A-11, the fact that opening the trap opens or modifies the impermeable membrane is illustrated by separation of parts of an impermeable membrane enclosure (a lure) that encloses the attractant release device during shipping and storage. By application of the principles in the attached FIGS. 1A-11. impermeable membrane enclosures, which may also include a mechanism for tearing open impermeable membrane enclosure (which stores the attractant) with one or more materials that have a higher tear strength than the impermeable membrane enclosure during the opening of a trap.

In general, at the beginning of the discussion of each of FIGS. 1A-7 is a brief description of each element, which may have no more than the name of each of the elements in the one of FIGS. 1A-7 that is being discussed. After the brief description of each element, each element is further discussed in numerical order. In general, each of FIGS. 1A-7 is discussed in numerical order and the elements within FIGS. 1A-7 are also usually discussed in numerical order to facilitate easily locating the discussion of a particular element. Nonetheless, there is no one location where all of the information of any element of FIGS. 1A-7 is necessarily located. Unique information about any particular element or any other aspect of any of FIGS. 1A-7 may be found in, or implied by, any part of the specification.

### The Trap Configuration

FIG. 1B shows a perspective view of an embodiment of an insect trap in a folded structure for shipping 100. The insect trap 100 may include a first piece 110, a second piece 120, a top tab 130, Edges A, and a bottom tab 140. In other embodiments the insect trap 100 may not have all of the elements or features listed and/or may have other elements or features instead of or in addition to those listed.

The traps and methods of this specification include using an amount of attractant sufficient to attract the target insects, wherein the attractant is packaged in an impermeable packaging film (e.g., a seal) such that the loss of the attractant between the time of manufacture and the time of opening for use is minimal.

The trap 100 may be configured in any way that allows for folding the trap 100 closed for shipping and/or transfer, and opening the trap 100 for use, such that, when the trap 100 is opened, a seal is broken or destroyed from an insect attractant source (a lure package is opened). In the specification, the terms removed, destroyed, and broken, and their conjugations, may be substituted for one another to obtain different embodiments. In some embodiments (e.g., that of FIG. 1A), the trap 100 is configured to be collapsed for shipping and then expanded to a configuration with an opening on either side permitting entry of one or more insects. The seal of the attractant is positioned in the trap 100 during manufacture in such a way that, when the trap is converted from the trap's compressed shipping configuration to the trap's open use configuration, the action of opening and configuring the trap 100 causes the sealed chamber to be broken or destroyed and the attractant is released. The configuration of the trap 100 may be any expandable configuration that allows for unsealing the attractant source at the time of expanding (or erecting) the trap. In some embodiments, allowing the unsealing of the attractant source at the time of expanding the trap 100 means that the sealed lure chamber is broken or destroyed as the trap 100 is expanded because the motion of pulling the two pieces apart also pulls the seal from the attractant source. In other words, the same motion that opens the trap 100 deploys the lure, so that the trap is ready for use with the sealed lure chamber opened and the attractant released. As a result, no extra time is required to open a lure pack and to place the lure into the trap 100 and there are no losses (or minimal losses) of attractants from the lure between manufacture and time of use due to absorption of the attractant into the trap 100 and associated packaging material. In an alternative embodiment, the sealed lure chamber can also be manually removed in an action that is separate from opening trap 100, at the time of expanding the trap 100 or shortly thereafter.

Many previous traps supplied attractant lures separately from the trap. A disadvantage of supplying attractant lures packaged separately from the traps is that in order to deploy the traps a separate set of actions may be needed to (1) open the trap, (2) open the attractant shipping package, and (3) place the attractant slow release device in the trap. The additional actions used in deploying the trap, requires the person deploying the trap to spend additional time while deploying the trap. While placing the attractant in the adhesive materials is an efficient method of supplying an insect trap with an attractant, a disadvantage is that placing the attractant in the adhesive may allow continual and often times an irreversible loss, such as by diffusion, of the attractant into the trap body material as well as the accompanying packaging material during storage and shipping. Thus, the amount of attractant remaining in the trap and available to attract the insects depends on the time and temperature at which the trap is stored (or shipped) before the trap is opened for use. The longer the time and the higher the temperature during the time between manufacture and deployment, the less attractant is available in the adhesive at the time of trap deployment. The efficiency of the trap and attractant combination in capturing insects is related to trap design, the adhesive and the rate of emission of the attractant. In the method of placing the attractant in the adhesive of the trap at the time of manufacture and the amount and rate of attractant emission from the trap are variable due to storage and other factors that contribute to the time between manufacture and trap deployment. The variation in time between the manufacture and deployment leads to variations in the rate of capture and in the total number of insects captured by the traps.

The evaporation of the attractant may nonetheless be desirable, because in order for at least certain attractants to work, the attractant needs to evaporate. Evaporation of the attractant allows the insects to detect the attractant prior to entering the trap 100. Attractants used in the trap 100 may evaporate once placed in the traps. Evaporation provides a manner via which the insects may detect the attractants prior to the insects entering the trap 100. Additionally, as a result of the evaporation, there is an increasing concentration of attractant as the insect moves toward the trap 100, which directs the insect to eventually come in contact with the adhesive of the trap 100.

In an embodiment, slow release formulations of the attractant are packaged within trap 100, so that the attractants will not evaporate during storage and shipping, but still retain the attraction properties that are assisted by evaporation. By using a slow release formulation, shipped inside a nonpermeable membrane package within trap 100, it is not necessary to supply the slow release formulation in a package that is supplied separately from traps.

Also, in an embodiment of trap 100, the packaging materials in which the attractants are packaged for shipment do not absorb the attractants (e.g., materials that are impermeable to the attractant), so that almost all of the attractants originally placed in the shipping packages during their manufacture remain in the release devices after storage and shipping.

In an embodiment, when the trap 100 is expanded, the insect trap allows for an attractant packaged in a small package (as shown in FIG. 1A) made of material impermeable to the attractant (a lure package) to be released. The impermeable membrane is attached to a part of the trap 100 so that when the trap 100 is expanded, the impermeable package containing the attractant will also be opened and the attractant released. By attaching the impermeable membrane to a portion of the trap 100, the disadvantage of having to separately open the attractant package may be avoided. Additionally, the disadvantage of slow loss of the attractant between the time of manufacture and trap deployment may also be avoided.

In one embodiment, the trap 100 may be constructed to absorb attractants in adhesive materials of the traps that are supplied on the surfaces of the trap. When the attractant is absorbed in adhesive materials of the trap, only one action is required to expose the attractant, which is the action of opening of the trap.

In another embodiment, the attractants may be either absorbed into solid matrices or enclosed in semi-permeable membranes for slow release (e.g., a slower release than when stored in an adhesive). For example, a trap may be constructed so that the attractant is absorbed into a matrix that is placed into the adhesive of the trap. When the attractant is thus absorbed in a matrix only one motion is required to open the trap and expose the attractant containing matrix which will release attractant. Since the matrix is not enclosed by an impermeable membrane the attractant will diffuse into the adhesive, trap body and trap packaging material during the time between manufacture and use.

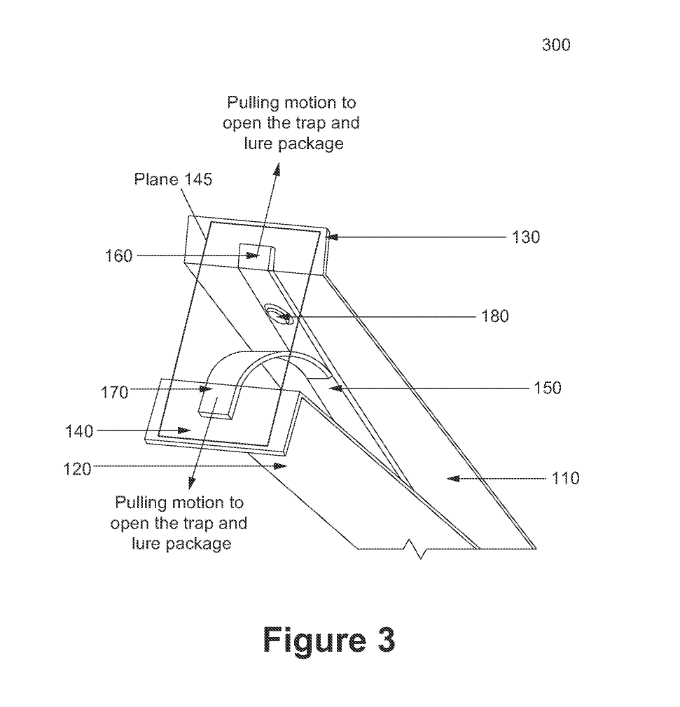

The first piece 110 may be any generally rectangular shape having edges A. By generally-rectangular shape, it is meant that the shape can include, but is not limited to, rectangular, square, oval, parallelogram, etc. The first piece 110 may be constructed of any material that contains enough flexibility that the first piece may be pulled apart at a fold. In some embodiments, the material is a flexible material, such as cardboard, paper, semi-rigid plastic (e.g., polyethylene, polypropylene, and the like), metal foil such as aluminum foil; paper or cardboard, which may be treated to be grease and/or water proof. The paper and/or cardboard may be found in a variety of thicknesses and flexibilities. In some embodiments, the material of first piece 110 is a thin material that is more conducive to flexing and adhering. In some embodiments, the material of first piece 110 does not absorb the attractant. In some embodiments, first piece 110 is composed of two generally rectangular pieces that are overlapped in the middle to create a tab. The bottom surface of the first piece 110 can also contain an insect adhesive, an attractant source, and/or a seal or a seal attachment. Embodiments having insect adhesive, an attractant source, and/or a seal or a seal attachment will be discussed in more detail in the discussion of FIGS. 3-7.

The second piece 120 may be of a shape that is approximately the same size and shape of the first piece 110. The second piece may be constructed of the same material as the first piece or may be constructed of a material with approximately the same flexibility. The second piece may be constructed of two pieces of material that are overlapped in such a way that a tab is created in the approximate middle of the second piece 120. Tab 130 is formed by the overlap of the two generally rectangular pieces of the first piece 110. Tab 140 is formed by the overlap of the two pieces of two material pieces of the second piece 120. The folded form of the first piece 110 and second piece 120 can result in the bottom surface of the first piece (the piece with the tab 130) and the top surface of the second piece being in close proximity and/or touching. The folded form creates a folded structure in which the two edges A each touch one another.

The top tab 130 and bottom tab 140 may be constructed by the overlap of the pieces used for the top and bottom of the trap (e.g., the first piece 110 and second piece 120). Alternatively, the tab 130 and 140 may be attached to a single folded piece using adhesive. The tabs 130 and 140 function as a finger grip, so that tabs 130 and 140 may be gripped with one's fingers, so that one may pull the two pieces, first piece 110 and second piece 120, apart to expand the folded insect trap and/or to activate the attractant.

The first piece 110 and the second piece 120 may be attached to one another at the edges A, such that when the pieces are pulled apart, a hollow quadrilateral container is produced. The two pieces, first pieces 110 and second pieces 120, may be attached at the edges with any type of adhesive. Adhesives are mixtures in a liquid or semi-liquid state that adhere or bond items together. Adhesives may come from either natural or synthetic sources. The types of materials that may be bonded are vast but they are especially useful for bonding thin materials. The adhesive may also include, but is not limited to, glue, staples, rivets, tape, and nails.

In some embodiments, the first piece 110 and second piece 120 may be treated with a protective coating to protect the first piece 110 and second piece 120 from weather conditions and/or to make the first piece 110 and second piece 120 not absorbent to the attractant. Protective coatings can include but are not limited to, polyethylene, plastic, wax or any other suitable agent.

The trap may be shipped in the folded trap 100 and may be nested into another folded trap 100. In some embodiments, the trap 100 is completely folded at the tab 130 so that the both edges A at either end of the trap 100 (or at either end of piece 110 or 120) are touching.

The trap 100 can also include such structures as a hanger, a data label, a warning label, a tripod for setting the trap on a surface. The hanger may be attached to the top surface of the first piece 110 typically in the middle so that the trap hangs evenly. In some embodiments, the hanger is attached to the tab 130. The hanger may be any device known in the art, but typically allows attachment to a tree branch, wall, roof, telephone pole, or any surface near which the insect of choice may be found. Examples of hangers include, but are not limited to, a wire, a string, a hook, and a twister. In some embodiments, the wire or string is twisted or tied around a tree branch (or other-structure). In some embodiments, the trap is set onto a surface or foliage such that the edges hold the trap in place.

To begin deploying trap 100, one separates edges A and then pulls on tabs 130 and 140, so as to pull tabs 130 and 140 away from one another.

FIG. 1B shows a perspective view of an embodiment of an insect trap in a folded structure for shipping 100. The insect trap 100 may include a first piece 110, a second piece 120, a top tab 130, Edges A, and a bottom tab 140. In other embodiments the insect trap 100 may not have all of the elements or features listed and/or may have other elements or features instead of or in addition to those listed.

FIG. 1B shows the trap during the first stage of the deployment process. Prior to FIG. 1B, edges A were touching one another, so that trap 100 is just one flat rectangular structure, which may be easily stored, stacked, and/or placed on a shelf in an orderly fashion. FIG. 1B shows trap 100 after edges A have been separated from one another (e.g., by pulling against the force of an adhesive holding edges A together). FIG. 1B shows the trap prior to pulling tabs 130 and 140 away from one another.

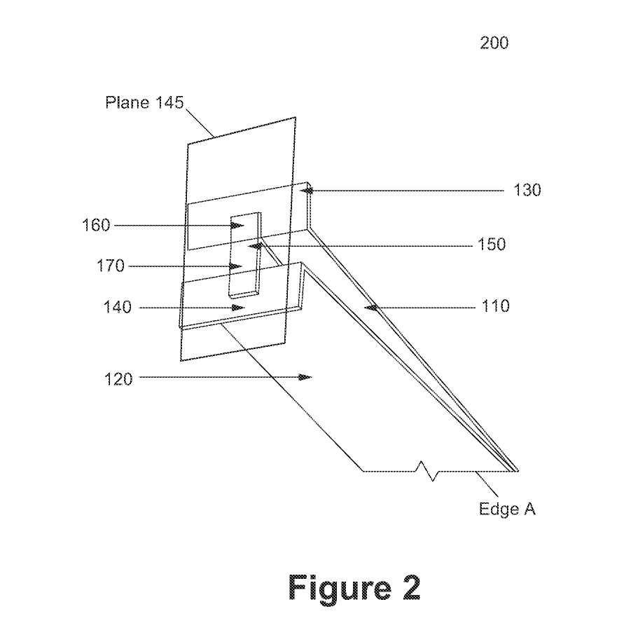

FIG. 2 is a view 200 of an embodiment of the trap of FIG. 1B cut along plane 145. In the FIG. 2 view, one side to the left of plane 145 is removed and the second side to the right of plane 145 is shown. In an embodiment, in the FIG. 2 view, the insect trap 100 may include a first piece 110, a second piece 120, a top tab 130, Edge A, a bottom tab 140, and a lure package 150 containing strips 160 and 170, which may include an attractant and a seal. In other embodiments, the insect trap 100 may not have all of the elements or features listed and/or may have other elements or features instead of or in addition to those listed.

The FIG. 2 view shows the attachment of the tab 130 of the first piece 110 of the trap body to one part of the lure package 150, strip 160, and the attachment of the bottom tab 140 of the second piece 120 to a part of the strip 170 (that is different than strip 160).

Lure package 150 may include an attractant source and a seal. The lure package 150 may be configured to ensure that the attractant is placed on an area that is the inside of the trap, such that the seal removably covers the attractant source. In this specification, any time the trap is said to be covered by the seal, the trap may be said to be surrounded by the seal to get a different embodiment, and any time the trap is said to be surrounded by the seal, the trap may be said to be covered by the seal to get a different embodiment. In some embodiments, the attractant is not surrounded by the seal (on strip 170) and/or is not absorbed by the trap body (and therefore not absorbed by the first piece 110 and second piece 120 of trap 100).

In an embodiment, strip 160 may contain the lure and attractant, while strip 170 may seal the lure and attractant closed until ready for deployment. Initially, prior to deployment, strips 160 and 170 are held together with an adhesive or by melting two plastic on strip 160 and plastic on strip 170 together. FIG. 2 shows the the start of the process of opening trap 100 for deployment (similar of FIG. 1B). As tabs 130 and 140 is pulled apart, strips 160 and 170 are pulled apart.

The seal on strip 170 may be used for the sealing the attractant source, and may include an impermeable membrane. In this specification, impermeable means that the attractant source cannot move through the membrane. In some embodiments, the impermeable membrane cannot allow movement of any substance that could inactivate the attractant source. The seal may be made of a material such as aluminum foil, polyamide film, or polyester film laminated with an ultraviolet, ultrasound, or thermally activated sealing barrier.

The seal can include an adhesive to removably attach the seal to the top and/or bottom of the trap (to the first piece and/or second piece), but which may be removed by the force of pulling the two pieces of the trap apart as the trap expands to the form in which the trap is used.

### Insect-Retaining Adhesive

The insect-retaining adhesive may be any adhesive that retains insects, including but not limited to, a glue, a sticky substance, wax, oils, oil mixtures, polyisobutene resins and mixtures thereof.

While, the insect retaining adhesive may be applied to any part of the trap, it would not be practical to apply the adhesive to areas that might be contacted by fingers, such as any part of the trap that would be contacted to open (or erect) the trap. In some embodiments, the insect-retaining adhesive is applied to the inside of the trap (the inner walls of first piece 110, 120, strip 160, and/or strip 170). Applying the insect retaining adhesive to the inside of the trap may include applying the insect retaining adhesive to the bottom surface of the top piece and/or the top surface of the bottom piece. The insect-retaining adhesive may be applied to any portion of the surface and/or surfaces, but in some embodiments, the insect-retaining adhesive is applied to approximately the entire surface of the inside of the trap. In some embodiments, the insect-retaining adhesive is not applied to the lure and/or lure adhesive. In some embodiments, the insect-retaining adhesive does not allow for the irreversible adhesion of one part (or piece) of the trap to another part or piece of the trap. An example of a suitable insect adhesive is Stickem™ which is produced by Seabright Laboratories, 4026 Harlan Street, Emeryville, Calif. 94608-3604.

FIG. 3 shows another view 300 of an embodiment of the trap 100 (cut along plane 145) of FIG. 2 in which the trap is pulled apart in a direction parallel to plane 145 to open the trap 100 and to pull a strip 170 (e.g, the seal) off of strip 160 (which may include the lure and insecticide). In the FIG. 3 view, the insect trap 100 may include a first piece 110, a second piece 120, a top tab 130, a bottom tab 140, a lure package 150 including at least top strip 160 and bottom strip 170 and attractant source 180. In other embodiments, the insect trap 100 may not have all of the elements or features listed and/or may have other elements or features instead of or in addition to those listed.

As, FIG. 3 shows trap 100 after the being opened an amount further than shown in FIG. 2. As shown in FIG. 3, a seal (e.g., strip 170) may be attached to the bottom tab 140 or the second piece 120. The seal may be any type of impermeable material, made by melting sealing barriers of strip 160 and strip 170 together or made of any material that is impermeable to the attractant. In an embodiment, the seal may be attached at only one end to the second piece 120 (and/or strip 170) so that as the lure is opened, the seal is removed from the attractant source until the seal is completely removed.

The attractant source 180 may be on and/or in strip 160, which is on the first piece 110 (on the top piece) and the bottom strip 170 (e.g., the seal) is attached to the second piece 120 (the bottom). However, in some embodiments, the attractant source 180 may be on the strip 170 on second piece 120 and the seal may be on the top strip 160 on first piece 110. The attractant source 180 and seal (e.g., strip 170) may be attached to the first piece 110 and second piece 120 using any adhesive as described in FIG. 1B. The lure package 150 may be constructed of an impermeable membrane or including layers of impermeable membrane surrounding attractant source 180 and/or as an out layer of lure package 150. The impermeable membrane may be included under the attractant source 180 and may be included as the seal (e.g., strip 170), to ensure that the attractant and/or insecticide is not absorbed into other parts of the trap 100 and/or evaporated into the air. The impermeable membrane may be any type of membrane that is not permeable to the attractant.

The attractant source 180 may include one or more attractants that attract any insect. The attractant source may be chosen based on the type of insect or insects to be attracted. For example, the insect attractant may be a pheromone, kairomone, food attractant, fragrance, and/or mixtures therein.

Advantages of using insect pheromones as attractants are that, unlike conventional pesticides, insect pheromones do not damage other animals, nor do they pose health risks to people. Pheromones can specifically disrupt the reproductive cycle of harmful insects. The pheromones may be any type of pheromone, including but not limited to, a sex pheromone, an aggregation pheromone, a trail pheromone, an alarm pheromone, a kairomone, swarming attractants, feeding attractants, a male-produced pheromone or a female-produced pheromone. Known sex pheromones include but are not limited to, cis-9-dodecen-1-yl acetate, cis-7-dodecen-1-yl acetate and trans-8, trans-10-dodecadien-1-ol. The attractants may be effective by themselves, or their attractiveness may be increased by adding a synergist. For example for cis-9-dodecen-1-yl acetate a synergist is Z11-tetradecen-1-yl acetate (Endopiza viteana). For cis-7-dodecen-1yl acetate both cis-9-dodecen-1-yl acetate and cis-11-hexadecen-1-yl acetate are synergists (Agrotis ipsilon) and for trans-8, trans-10-dodecadien-1-ol a synergist is trans-8, trans-10-dodecadien-1-yl acetate (Cydia pomonella).

Depending on the attractant or attractant source 180, trap 100 may be used to attract and/or catch insects. The insects that are attracted to the trap can include, but are not limited to, the grape berry moth (E. viteana), black cutworm (A. ipsilon) and codling moth (C. pomonella). By using different pheromone attractants or other insect-specific attractants according to the particular insect being targeted and/or by using food attractants are can each attract a large variety of insects, the traps can capture many different orders of insects including, but not limited to, Coleoptera, Diptera and Lepidoptera that attach to row crops, such as cotton and corn or hang in storage and processing areas where crops are stored and processed.

The attractant source 180 may be an amount of the attractant spotted or otherwise placed onto a portion of the trap and/or on a material (matrix) attached to the trap in an area inside the trap. In some embodiments, the attractant source 180 is initially contained within a matrix to affect slow release. The attractant may be placed within the matrix by absorption. A matrix is any substance that will reversibly adsorb the attractant. Examples of common matrices that reversibly adsorb insect attractants are polar and non-polar polymers such as polyvinyl chlorides, polyvinyl acetates, polyurethanes, polyamides, polyesters and polyhydrocarbons (polyethylene, polybutadiene). Zeolites, clays, and related inorganic materials also function well as reversible adsorbers of insect attractants. Natural and synthetic fibers such as wood, cotton, cellulose acetate and spun fiber plastics serve well as reversible adsorbers of insect attractants. A unique absorbent is electrostatically charged wax which will adhere to the bodies of arriving insects. When electrostatically charged wax is used, in an embodiment, no adhesive would be used in the trap and the insect would escape to act as a discrete mobile attractant source luring other insects toward the electrostatically charged wax in unproductive mating or foraging activity.

In some embodiments, the attractant source 180 is enclosed in a semi-permeable membrane (e.g., in addition to or instead of an impermeable membrane in which attractant source is kept prior to deployment) to effect slow-release of the attractant during deployment prior to deployment and during deployment. In some embodiments, a semi-permeable membrane allows for movement of some attractant molecules through the membrane. In an embodiment, a semi-permeable membrane may be chosen such that attractants permeate through the membrane, so that the realease is slow enough so that there is still attractant in trap 100 at the time of deployment, but fast enough of attract insects. Any molecule with a vapor pressure that allows evaporation at room temperature will permeate through a plastic membrane as long as the membrane has a polarity similar to that of the attractant molecule. That is non-polar attractants with significant vapor pressure at room temperature permeate through non-polar membranes such as polyhydrocarbons while polar attractants with significant vapor pressure at room temperature permeate through polar membranes such as polyamides. Semipermeable membranes may be purchased from The Dow Chemical Company, 2030 Dow Center, Midland, Mich. 48674.

In some embodiments, the attractant source 180 is shipped and stored in a sealed package made of an impermeable membrane. Impermeable membranes are those that contain films of impermeable materials such as aluminum.

The attractant source 180 may be attached to the top tab 130 or to the first piece 110. The attractant source can include any type of attractant (see also the section entitled “lure package”). The attractant source may include the attractant absorbed in another material, included in a semi-permeable membrane, and/or included in a matrix such as electrostatic wax (as described above). The attractant source may be of a size that is less than the width and length of the first piece 110, including but not limited to 80%, 70%, 60%, 50%, 40%, 30%, 20% and 10% of the size of the first piece 110, for example. In some embodiments, the attractant source 180 is located on one side of strip 160 placed in the center of one side of the first piece 110 extending from the tab 130 to the Edge A (e.g, the attractant source may extend the entire length of strip 160 or may be located on just a portion of strip 160. In an embodiment, the attractant source can also be included on both sides of strip 160 both attached separately to the top tab 130 or to the top of the first piece 110.

The top surface of the second piece 120 and/or the bottom surface of the first piece 110 can also include an insect adhesive. In some embodiments, the insect adhesive is included on the top and bottom of the inside of the trap except where the attractant source 180 is located.

FIG. 3 shows the opening of the seal as one part of the trap body is pulled in a direction different than that of the other part of the tab 140. Since one part of the lure package 150 is attached to trap body tab 130 and another part of the strip 170 is attached to a different part of the tab 140 this pulling motion causes the separation of strip 160 and strip 170 of the lure package, removing the seal (e.g., strip 170) and exposing the previously enclosed surfaces of strip 160 and strip 170 of the lure package 150. Removing seal (e.g., strip 170) further exposes the attractant source 180.

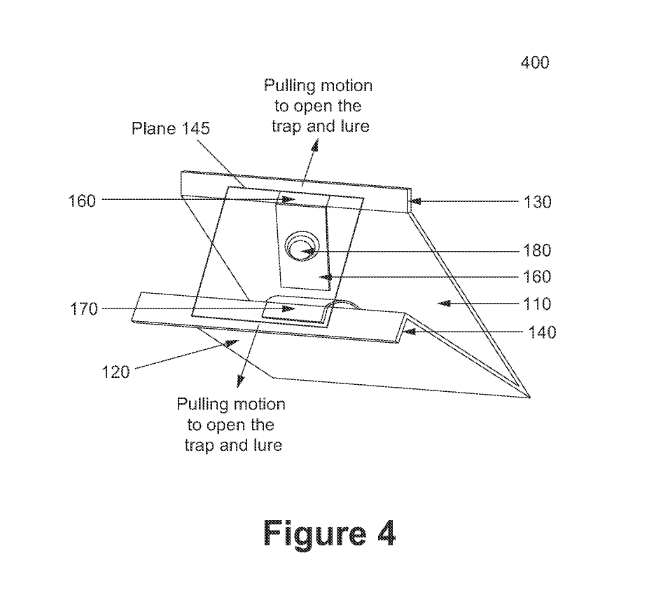

FIG. 4 is a perspective view 400 of an embodiment of the trap 100 of FIG. 3 to show a more advanced stage of separation of tab 130 of the trap body from tab 140 of the trap body. At the stage shown in FIG. 4, the part of the lure package 150 that is attached to tab 130 of the trap body has completely separated from the other part of the lure package strip 170 which is attached to tab 140 of the trap 100. FIG. 4 then shows the attractant source 180 exposed by the separation of strip 160 and strip 170 of the lure package 150.

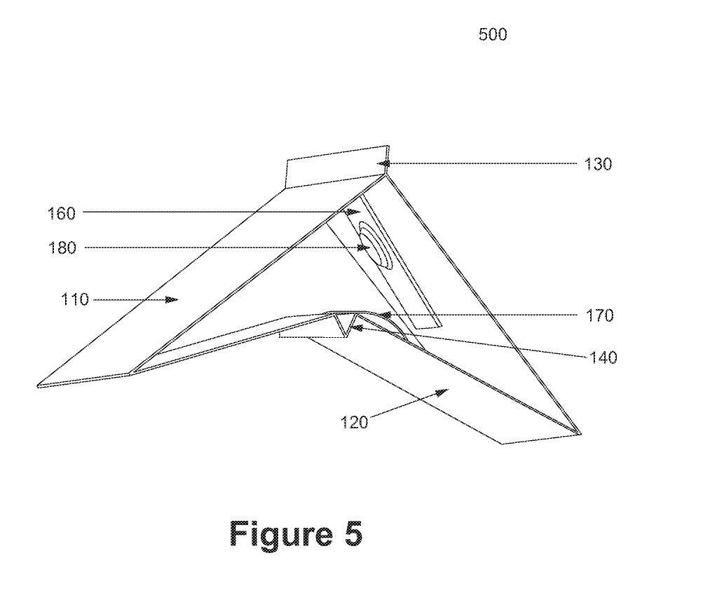

FIG. 5 is a perspective view 500 of an embodiment of the trap 100 of FIG. 1 in which the side of the trap to the left and to the right of plane 145 (FIG. 4) is shown. FIG. 4 shows approximately the separation of tab 130 of the trap body from tab 140 of the trap body. At the stage shown in FIG. 5, the part of the lure package 150 that is attached to tab 130 of the trap body has been completely separated from strip 170 of the lure package 150 (and the attractant source 180 hangs one strip 160, which is attached to and hangs form tab 130 of the trap body. FIG. 5 shows the attractant source 180 exposed by the separation of strip 160 and strip 170 of the lure package.

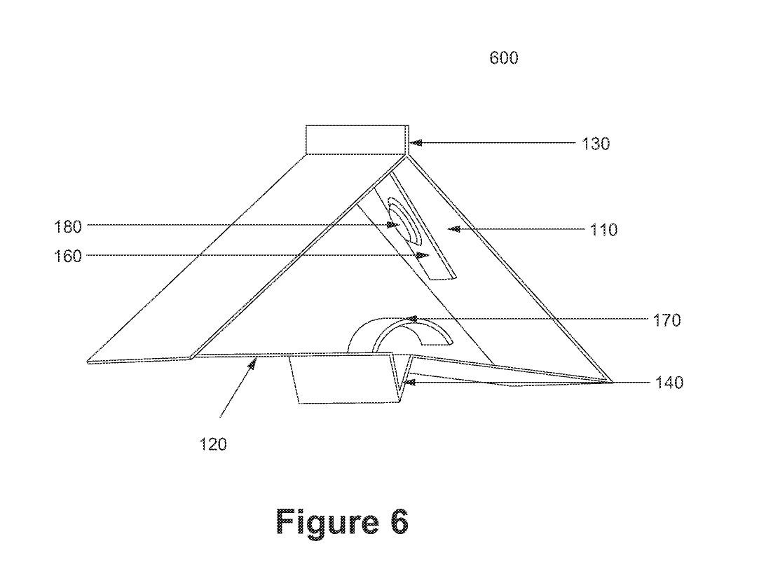

FIG. 6 is a perspective view of an embodiment 600 of the trap 100 of FIG. 1. However, in FIG. 6, the separation of tab 130 of the trap body from tab 140 of the trap body is greater than shown in FIG. 5. At the stage shown in FIG. 6 the part of the lure package 150, strip 160, that is attached to tab 130 of the trap body (the attractant source 180) has been completely separated and is more distant from strip 170 of the lure package 150, which is attached to tab 140 of the trap 100. FIG. 6 shows the attractant source 180 exposed by the separation of strip 160 and strip 170 of the lure package 150. In some cases, the trap 100 would be deployed for use in the configuration of FIG. 6. In some embodiments (see e.g., Examples 1 and 2) the internal surfaces of the trap are covered with insect retaining adhesive. Alternatively, if electrostatic wax is mixed with the attractant then the internal surfaces of the trap would not necessarily contain adhesive.

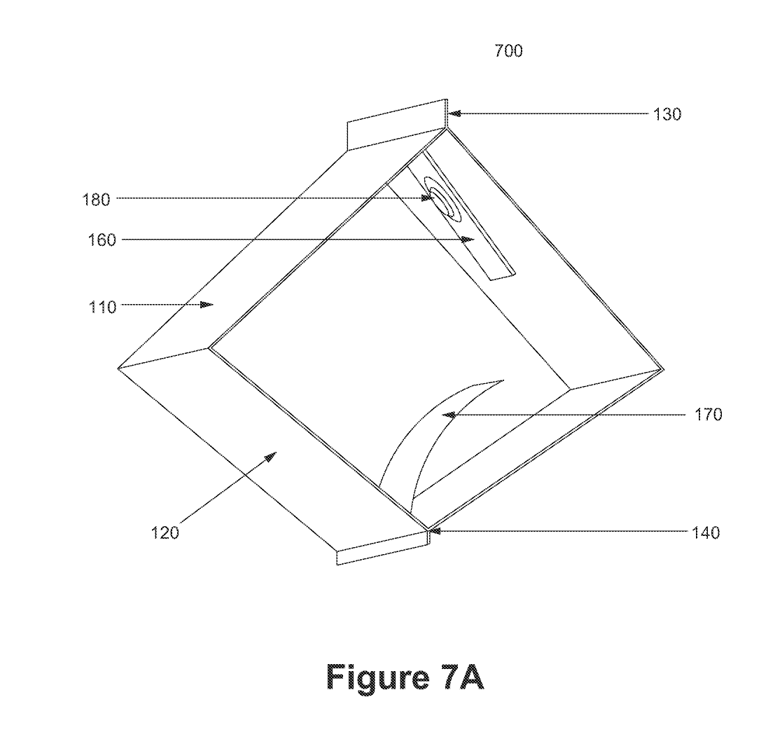

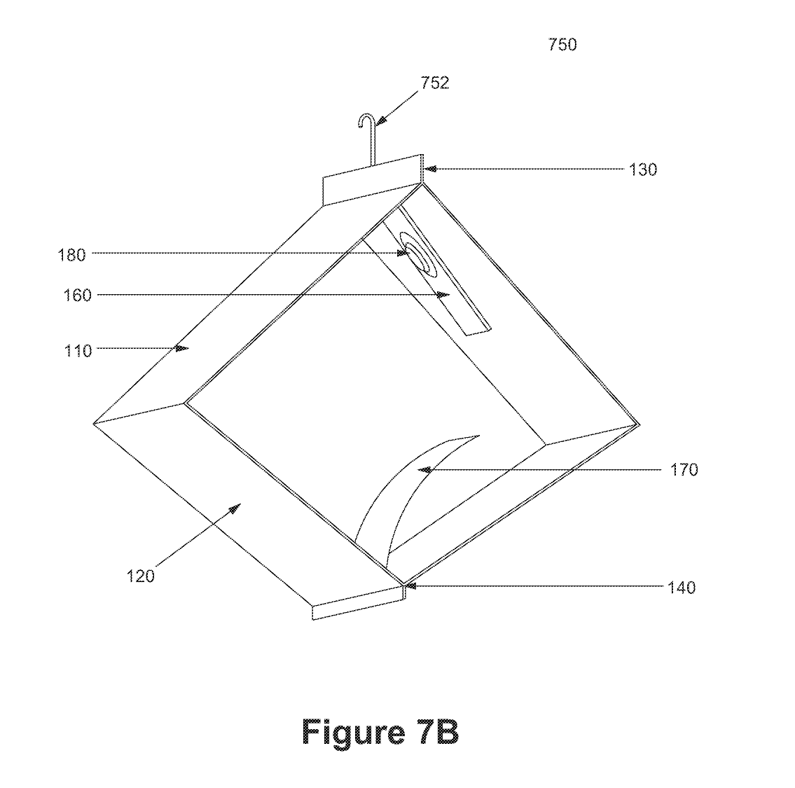

FIG. 7A is a perspective view of an embodiment 700 of the trap 100 of FIG. 6 but in which the separation of tab 130 of the trap body from tab 140 of the trap body is at the trap's usual amount of separation for use of the trap. The configuration of FIG. 7A allows for the largest entrance for insects as compared to the other configurations disclosed. The interior surface of the trap may be covered in insect retaining adhesive. At the stage shown in FIG. 7A, the part of the lure package 150 that is attached to tab 130 of the trap body has completely separated and is distant from strip 170 of the seal which is attached to tab 140 of the trap body. FIG. 7A shows the attractant release device for attractant source 180, in which the attractant has been exposed by the separation of strip 160 and strip 170 removing the seal. In some cases the trap would be deployed for use in the configuration of FIG. 7A having the the attractant has been exposed by the separation of strip 160 and strip 170 of the seal. As described in Examples 1 and 2, the internal surfaces of the trap may be covered with insect retaining adhesive.

FIG. 7B is a perspective view of an embodiment of the trap 750. Trap 750 includes pieces 110 and 120, tabs 130 and 140, lure package 150, strips 160 and 170, attractant source 180, and hanger 752. In other embodiments the insect trap 750 may not have all of the elements or features listed and/or may have other elements or features instead of or in addition to those listed.

Trap 750 may be an embodiment of trap 100. The embodiment of FIG. 7B differs from that of FIG. 7A in that the embodiment of FIG. 7B has a hanger 752. Hanger 752 may be used for hanging the trap from a tree or other location. Instead of the hanger illustrated in FIG. 7B, hanger 752 may be replaced with another hanger, such as any of the other hangers as discussed above in conjunction with FIG. 7B.

### Packaging

The traps may be packaged or wrapped individually but may also be removably attached to each other so that more than one may be opened at once. Thus, if a user wants to place two traps in the same place, a package of two may be removed and the two may be pulled apart at the same time or separately, releasing the attractant. In some embodiments, the traps are wrapped so that traps are not accidentally pulled apart within the package.

### Methods of Using the Device

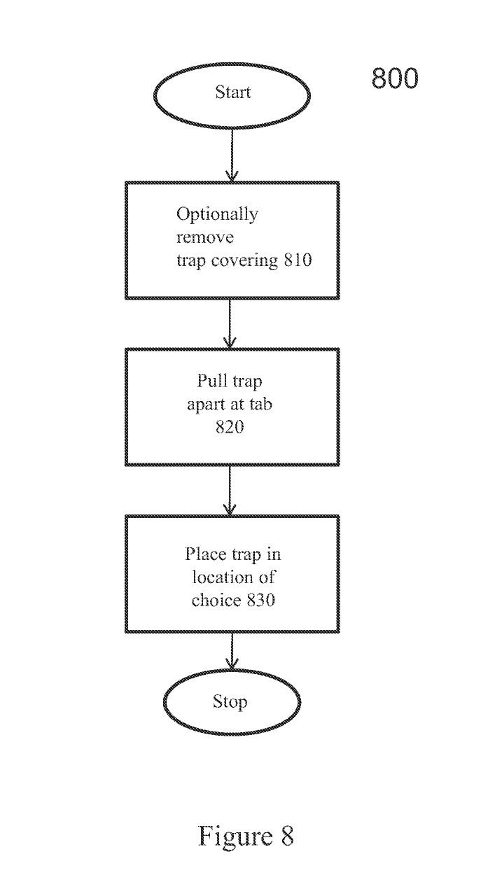

FIG. 8 shows a flow chart of an embodiment of method 800 in which a trap is opened and activated to trap insects.

In step 810 the wrapping, covering, and/or packaging of trap 100 is removed. In some embodiments, the trap does not have a covering, making step 810 optional.

In step 820 the trap 100 is pulled apart by pulling tabs 130 and 140 away from one anothers. As the tabs 130 and 104 are pulled apart, strips 160 and 170 are pulled apart, and the seal (e.g., on strip 170) is separated from the attractant source 180 (see FIGS. 2-7) and the attractant is released. The trap may be pulled apart to allow entrance of the insects into the interior of the trap. In some embodiments, the trap is pulled apart far enough to completely destroy or break the seal from the attractant source. If, due to a malfunction or defect, the seal is not removed, the seal may be removed manually.

In step 830 the trap is placed in a location of choice. In some embodiments, the trap is attached to a tree or branch and includes a hanger.

Once the trap is opened and activated, the trap may be monitored to identify the number and/or type of insects that are trapped. In some embodiments, the lure package may be replaced when a majority of the attractant is evaporated. In some embodiments, when the attractant is evaporated, the trap is removed and a new trap is placed.

In an embodiment, each of the steps of method 800 is a distinct step. In another embodiment, although depicted as distinct steps in FIG. 8, step 810-830 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

Trap 100 may be used for exterminating insects. Trap 100 may be used to identify the presence of an insect in an area, to quantify insects in an area, to track insect populations, to identify stages of development of insect populations, and/or to remove insects from an area. In other words, the traps may be used as a monitoring device, or as an insect removal device. In some embodiments, monitoring insects, via the trap, allows farmers to track insect population growth and stages of development. By monitoring the insect via the trap, farmers can reduce the amount of insecticide they need—spraying only when the insects are in a vulnerable stage or when their numbers exceed certain levels.

In some embodiments, the trap may be used as a monitoring device as an aid in exterminating insects (e.g., household insects). Monitoring, via the trap, may be used to determine the location, traffic patterns and density concentrations of pests (which may be helpful in identifying the location of a nest of insects—such as an ant colony or hornet's nest) in a building or other environment so as to more efficiently exterminate the pest population by reducing the amount of chemical spray.

### EXAMPLES

Aspects of the present teachings may be further understood in light of the following examples, which should not be construed as limiting the scope of the present teachings in any way.

The following examples illustrate the benefits achieved by the apparatus and methods herein. The examples show the benefits to be gained by used of the expandable insect trapping device in the deployment of diamond traps usually used to monitor for lepidopteran pests of stored products in the genera Ephestia and Plodia. The traps use the attractant known as cis-9, trans-12-tetradecadien-1-yl acetate which is the female sex pheromone for Ephestia cautella, Ephestia elutella, Ephestia kuehniella and Plodia interpunctella and attracts males of all four of these species. Cis-9, trans-12-tetradecadien-1-yl acetate is available from Bedoukian Research, 21 Finance Drive, Danbury, Conn., 66810. Diamond traps used in this study measured 19 cm×14.6 cm when fully extended flat and 10.5 cm×14.5 cm when folded into shipping form an a square 8.5 cm×7 cm on adjacent sides as in U.S. Pat. No. 3,755,958 when opened.

### Example 1

Diamond traps, as of the dimensions above and containing a total interior surface of 32 cm×13.5 cm made sticky by application of 5 grams of the adhesive tradename Stickem™ (Seabright Laboratories, 4026 Harlan Street, Emeryville, Calif. 94608-3604) were prepared and thermally sealed singly in aluminum foil packages that would are used for shipping and storage. In an initial trial the time was recorded to deploy each of 10 traps. This was done by measuring the time it took to open each of the shipping packages, opening of each trap, attachment of hang wire to each trap and hanging of each trap on a 1.25 cm diameter aluminum rod hung horizontally 2 meters from the ground. In a second trial the time was recorded to deploy each of 10 traps and to bait them with prepackaged lures. This was done by measuring the time it took to open each of the shipping packages, opening of each trap, attachment of hang wire to each trap, open an aluminum package containing a pheromone lure for each trap and place one lure in the trap and hang each trap with a lure on a 1.25 cm diameter aluminum rod hung horizontally 2 meters from the ground.

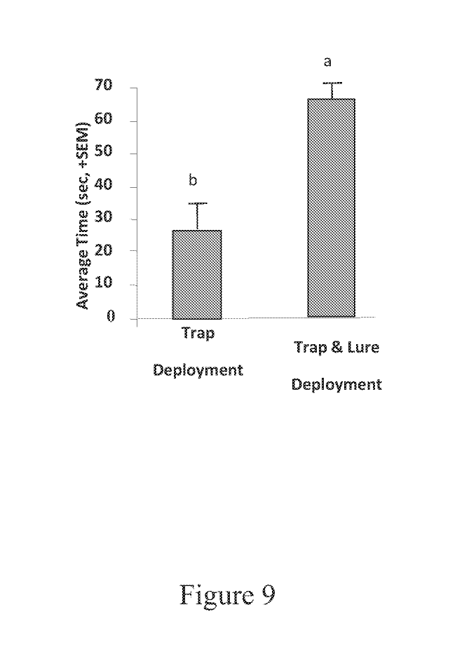

FIG. 9 shows the average (and Standard Error of the Mean, SEM) time in seconds that it took to deploy each of 10 diamond traps as described above compared to the time it took to deploy each of 10 diamond traps containing an opened prepackaged lure and place the lure in each trap before hanging each trap. Different letters at the top of the bars in FIG. 1B indicate that the averages are significantly different to (P>0.05).

### Example 2

Diamond traps, as of the dimensions above and containing a total interior surface of 32 cm×13.5 cm made sticky by application of 5 grams of the adhesive tradename Stickem™ (Seabright Laboratories, 4026 Harlan Street, Emeryville, Calif. 94608-3604) containing 5 mg of cis-9, trans-12-tetradecadien-1-yl acetate per 5 grams of Stickem were prepared and thermally sealed singly in aluminum foil packages that would are used for shipping and storage. These traps were packaged singly in aluminum packaging used for shipping and storage which was known to be impermeable to cis-9, trans-12-tetradecadien-1-yl acetate. The traps that were thus prepared were stored under the following sets of conditions:
10 Traps stored at 20° C. in a constant temperature chamber for 6 months.
10 Traps were stored at 30° C. at a constant temperature chamber for 6 months
10 Traps were stored at −20° C. in a freezer for 6 months

After the storage time, all of the above traps were removed from their storage conditions and 10 Diamond traps were freshly prepared using the same batch and load of cis-9, trans-12-tetradecadien-1-yl acetate (so the stored traps and the freshly prepared traps could be compared). Additionally, 10 traps were prepared that were stored in at 30° C. for 6 months but did not have cis-9, trans-12-14Ac in the adhesive. The traps that were stored in at 30° C. for 6 months (but did not have cis-9, trans-12-14Ac in the adhesive) were prepared with thermally sealed aluminum pouches containing lures containing 5 mg of cis-9, trans-12-tetradecadien-1-yl acetate. Sealed aluminum pouches were mounted in traps such that the sealed aluminum pouches would open as in FIGS. 1A-7 when the traps were opened as described in FIGS. 1A-7. Thereafter, all 50 traps were deployed in a grain storage facility for 2 weeks with trap positions changed each week. The cis-9, trans-12-tetradecadien-1-yl acetate is a sex pheromone for the grain infesting moth, Plodia interpunctella, which was present in the grain storage facility. After two weeks total captures in all traps were determined and statistical analysis performed so that average captures that were significantly different could be differentiated.

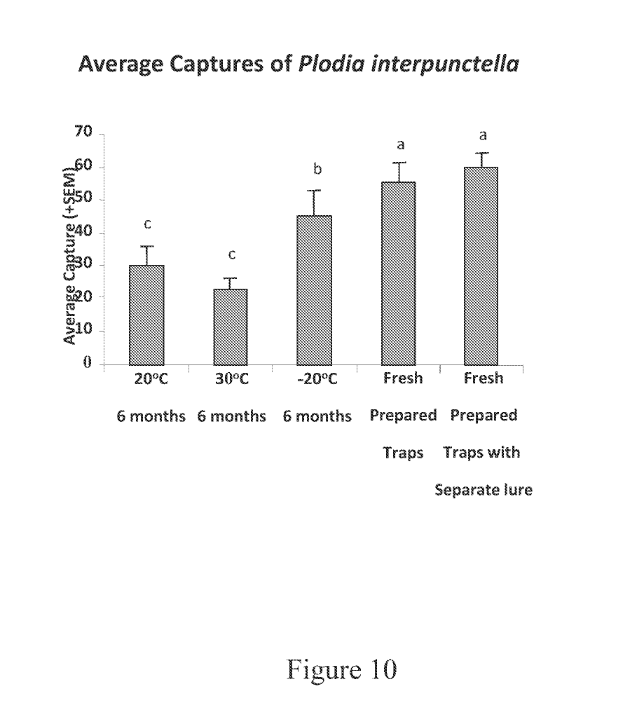

FIG. 10 shows the results of the test and shows that storage of the pheromone impregnated adhesive at 20° C., 30° C. and even at −20° C. for 6 months resulted in traps that captured significantly less Plodia interpunctella than traps that were freshly prepared with pheromone impregnated in the adhesive and traps baited with pheromone lures sealed in impermeable aluminum pouches that had been stored at 30° C. for 6 months prior to use.

Throughout this specification, where ever the term “attractant” is used, a combination of an attractant and an insecticide may be substituted to obtain another embodiment. In this specification anywhere the term attractant source is used, a reservoir, matrix, spongy material, and/or a mesh holding an attractant and/or insecticide may be substituted to obtain another embodiment.

### Methods of Making the Device

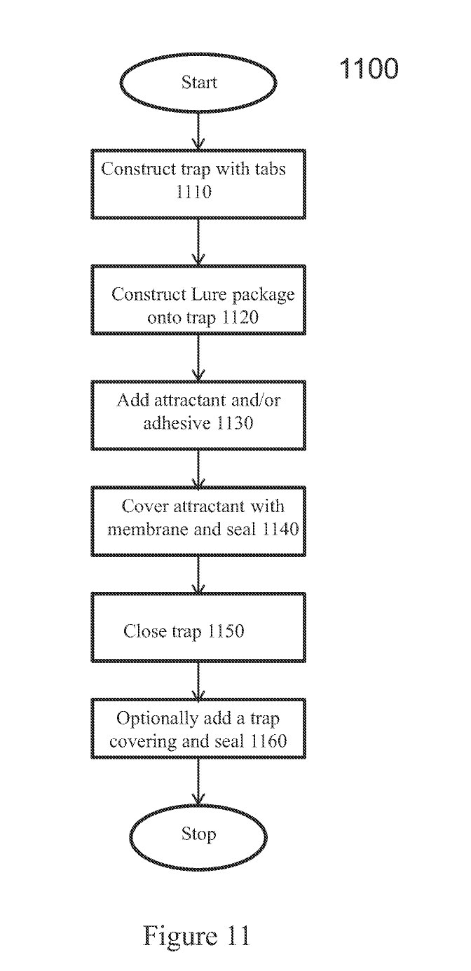

FIG. 11 shows a flow chart of an embodiment of method 1100 of making the trap shown in FIGS. 1A-7.

In step 1110 the trap is constructed in a way that allows for folding the trap closed and opening the trap for use. For example, attractant source 180 may be formed, such as by adding attractant to a matrix.

The trap 100 may be composed of any material that allows for the expandability, but is rigid enough to maintain the shape. The trap 100 may be constructed to have two tabs (130 and 140) that, when pulled apart, result in the opening of the trap and concurrently, the removal of the seal from the lure package. The parts of the trap may be constructed of the same or different materials. The parts of the trap may be attached using any means known in the art, including but not limited to, adhesives, staples, heat, etc. Some parts of the trap 100 may be removably attached, while other parts are more permanently attached. Having some parts removably attached and some part permanently attached may be accomplished using different methods of attachment and/or different levels of attachment, e.g., by using adhesives having different strengths.

In step 1120 the lure package 150 is constructed onto the trap 100. The lure package 150 and the trap 100 may be constructed of the same or different materials. The lure package 150 and trap 100 may be constructed at the same time or separately. The lure package 150 may be constructed to allow for the removal of a seal coving the attractant, by removing strip 170, when the trap is opened and/or the tabs are pulled apart. The lure package can include an area for applying an attractant, an area for applying an adhesive, and an area for applying a seal. Parts of the lure package (e.g., the seal) may be removably attached to the lure package.

For example, strips 160 and 170 may be formed. A well or recess may be formed in strip 160, which may be lined with an impermeable material that is adhered to the walls and bottom of the well, and attractant source may be placed into and adhered to strip 160. A portion of the rest of or the rest of the surface of strip 160 having the well may be covered with insect retaining adhesive. Strip 170 may be formed from an impermeable material with an adhesive on the side facing strip 160.

In step 1130 an attractant is added within or on the lure package. The attractant may be any type of attractant discussed herein. An adhesive can also be applied in or around the lure package and/or on the area of the trap surrounding the lure package. The adhesive may be admixed with the attractant or may be separate from the attractant or both.

In step 1140 the attractant is removably covered with a membrane or seal in such a way that the attractant is protected from evaporating. The membrane or seal may be any type of membrane or seal discussed herein. The membrane or seal may be attached to the trap or lure package in such a way that when the trap is opened, the attractant source is exposed and made available. The seal may be attached so that that the seal or parts of the seal may be removed manually or the seal may be attached so that the seal or parts of the seal are automatically removed during the opening of the trap.

For example, first piece 110 and second piece 120 may be constructed. One end of strip 160 is adhered to a portion of first piece 110 that is used for forming tab 130. One end of strip 170 is attached to the portion of second piece 120 that is used for forming piece 120. Then tabs 130 and 140 may then be formed, by folding the rectangular pieces of material or by adhering together two ends of two pieces of material for piece 110 and adhering together two pieces of material for piece 120. Then the ends of piece 110 are attached to the ends of piece 120.

In step 1150, the trap is closed or refolded such that when the tabs are pulled, the trap may be opened and the seal will be opened exposing the attractant. For example, the surface of piece 110 that faces the surface for piece 120 and the surface for piece 120 that faces piece 110 are brought together. In the process, strips 160 and 170 are brought into contact with one another and adhered to one another, there by sealing source. Then edges A are brought together.

Steps 1110, 1120, 1130, and 1140 may be performed separately or concurrently. It is envisioned that it may be easier to construct the trap and lure at the same time, in parts and/or to add the attractant and adhesive during the construction of the trap and lure. Further, it may be advantageous to have the trap partially closed during construction of the lure package and the seal, to ensure that the seal is not removed during construction.

In step 1160 a trap covering is optionally added that encloses the folded trap in a protective covering. This protects the trap and keeps the trap from being accidentally opened (pulled apart) and/or the seal being broken upon storage and/or transport.

The method may also include attaching a hanger and/or attaching a tag for writing on the device. The method may also include writing instructions and/or labels indicating what different parts of the device are directly on the device. The method may also include providing separate instructions and/or explanations of the device, attractant and/or adhesive, within the packaging and/or attached to the device. The method may also include decorating and/or coloring the device in such a way that the device will attract insects and/or be hidden from view. This may include decorating the device to blend in with plants or trees. The method may also include attaching a device to the trap that allows the device to more easily be found.

In an embodiment, each of the steps of method 1100 is a distinct step. In another embodiment, although depicted as distinct steps in FIG. 11, step 1110, 1120, 1130, 1140, and 1150 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### Alternatives and Extensions

Each embodiment disclosed herein may be used or otherwise combined with any of the other embodiments disclosed. Any element of any embodiment may be used in any embodiment. For example, during construction of the trap 1100, alternative construction of the tabs may involve attaching separate pieces to the trap rather than the tabs 130 and 140 being formed as part of the trap 100. Further, substances and/or materials may be used to hold the attractant onto or within the trap 100. Substances for holding the attractant may include, but are not limited to, adhesives, matrices, absorbent paper, carriers, cloth, etc.

In some embodiments, replacement attractant and/or adhesive patches may be supplied to make the trap 100 reusable. For example, the area containing the attractant in the lure package may be a removable patch. When one attractant is used up, a new patch containing fresh attractant may be added on top of the old or to replace the old patch. Alternatively, replacement lure packages containing fresh attractant may be provided that can include a seal.

In some embodiments, a device may be included on or in the trap 100 that allows the trap 100 to be found more easily in a complicated environment. For example, if the trap is set in the middle of a jungle, the device may allow the trap to be more easily seen or found (e.g., a small amount of metal that allows the device to be found with a metal detector, etc).

In some embodiments, the trap 100 may be configured and/or decorated to be more attractive to the specific insects. Alternatively, the trap 100 may be decorated to be hidden from curious hikers, birds, etc. by blending into the plant or tree that the trap may be attached to.

In an embodiment, strip 160 and/or 170 is not included. Instead, the attractant source 180 may be placed directly into first piece 110. Similarly, piece 120, without strip 170, may act as the seal sealing the attractant source 180 prior to deployment (whether or not attractant source 180 is placed directly into first piece 110 or in strip 160). As mentioned above, in any of the embodiment, the roles of first piece 110 and second piece 120 and/or strip 160 and 170 may be reversed. The attractant source may be located on strip 170 and/or on second piece 120 and the seal may be located in first piece 110 and/or strip 160.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. An expandable insect trapping device, comprising:
a first piece of material and a second piece material each having a top and bottom surface, and, when closed, the bottom surface of the first piece and the top surface of the second piece are in contact;
an attractant source located between the first piece of material and the second piece of material and attached to a portion of first piece of material and the second piece of material at a first location;
a seal attached to one surface of one of the first piece of material and the second piece of material, the seal sealing the attractant source and attached to one of the first piece of material and second piece of material at a second location that is different from the first location, so that as the first piece of material and the second piece of material are separated from one another the seal is removed from the attractant source.

2. The expandable insect trapping device of claim 1, the seal comprising an impermeable membrane wherein the sealed attractant source is sealed with an impermeable membrane.

3. The expandable insect trapping device of claim 1, further comprising an adhesive attaching the first piece to the second piece.

4. The expandable insect trapping device of claim 4, wherein the adhesive is applied to the bottom surface of the first piece and/or the top surface of the second piece to hold the first piece to the second piece.

5. The expandable insect trapping device of claim 1, wherein the attractant source is an attractant absorbed in a matrix.

6. The expandable insect trapping device of claim 1, wherein the attractant source is an attractant applied to the inner surface of the semi-permeable membrane.

7. The expandable insect trapping device of claim 1, wherein the attractant source is enclosed in a semi-permeable membrane.

8. The expandable insect trapping device of claim 1 wherein the attractant source is an attractant mixed with an electrostatically charged wax.

9. The expandable insect trapping device of claim 1, further comprising a data label.

10. The expandable insect trapping device of claim 1, wherein said first and second piece each comprise two rectangular sides joined along adjacent edges which, when erected, form a hollow quadrilateral container, the sides being formed of a flexible material with the edges of the sides being joined at folds and with three of the folds being reinforced to give structural stability.

11. The expandable insect trapping device of claim 1, further comprising a hanger fastened to the container.

12. The expandable insect trap of claim 1, further comprising a tab formed in the middle of the first piece of material.

13. The expandable insect trap of claim 12, the tab formed in the first piece of material being a first tab, the expandable insect trap further comprising a second tab formed in the middle of the first piece of material, pulling the first tab and second tab away from one another deploys the expandable trap.

14. The expandable insect trap of claim 13, further comprising a strip of material on which the attractant source is located; the strip hangs when the expandable trap is deployed;

15. The expandable insect trap of claim 14, further comprising a second strip having the seal for the attractant source; deploying the expandable trap separate the seal from the attractant source by separating the first strip from the second strip.

16. The expandable insect trap of claim 15, the first strip being attached to one of the first tab and the second tab and the second strip being attached to another of the first tab and the second tab.

17. A method of trapping insects, comprising
providing the expandable insect trapping device of claim 1;
opening the expandable insect trapping device, the opening of the expandable insect
trapping device releasing the attractant; and
setting the expandable insect trapping device in an area of interest.

18. A method of shipping an expandable insect trapping device, comprising:
providing the expandable insect trapping device of claim 1 in a closed shipping configuration, wherein the attractant source is shipped and stored with the trap in a sealed impermeable membrane; wherein said trap is erected by opening said expandable insect trapping device and tearing the sealed impermeable membrane.
